(19) United States
(12) Patent Application Publication
(10) Pub. No.: US 2013/0202782 A1
(43) Pub. Date: Aug. 8, 2013

(54) Thin Film Permeation Barrier For Devices And Substrates

(71) Applicants: Prashant Mandlik, Lawrenceville, NJ (US); Ruiqing Ma, Morristown, NJ (US); Jeff Silvernail, Yardley, PA (US)

(72) Inventors: Prashant Mandlik, Lawrenceville, NJ (US); Ruiqing Ma, Morristown, NJ (US); Jeff Silvernail, Yardley, PA (US)

(73) Assignee: Universal Display Corporation, Ewing, NJ (US)

(21) Appl. No.: 13/365,921

(22) Filed: Feb. 3, 2012

(51) Int. Cl. H05B 33/10

(52) U.S. Cl. 427/66

(57) ABSTRACT

A method for fabricating a device having a barrier layer over a substrate is provided. A first sublayer of the barrier layer may be deposited via chemical vapor deposition using a first set of deposition parameters. The first set of deposition parameters may include a power density, a deposition pressure, a non-deposition gas flow rate and a deposition gas flow rate. One or more parameters may be set related to the flow ratio of non-deposition gas to deposition gas multiplied by the power density, or the power density divided by (1) the deposition pressure, (2) the sum of the non-deposition gas flow rate and the deposition gas flow rate, or (3) the precursor gas flow rate. The material of the first barrier layer may be selected to have a particular plasma etch rate compared to the etch rate of thermally growth silicon oxide under the same etching conditions.

This invention was made with government support under (identify the grant) awarded by (identify the federal agency). The government has certain rights in the invention.

The claimed invention was made by, on behalf of, and/or in connection with one or more of the following parties to a joint university corporation research agreement: Regents of the University of Michigan, Princeton University, The University of Southern California, and the Universal Display Corporation. The agreement was in effect on and before the date the claimed invention was made, and the claimed invention was made as a result of activities undertaken within the scope of the agreement.

### FIELD OF THE INVENTION

The present invention relates to permeation barriers and methods for making such barriers.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

One example of a green emissive molecule is tris(2-phenylpyridine) iridium, denoted Ir(ppy)₃, which has the following structure:

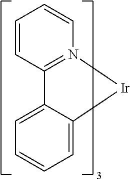

In this, and later figures herein, we depict the dative bond from nitrogen to metal (here, Ir) as a straight line.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

As used herein, if one layer is described as being positioned or deposited “over” another layer, intervening layers may also be present. A first layer is “over” a second layer generally when the first layer is disposed further from the substrate, i.e., which generally means that the first layer was deposited after the second layer. The word “under” also allows for intervening layer in a manner similar to “over.”

More details on OLEDs, and the definitions described above, can be found in U.S. Pat. No. 7,279,704, which is incorporated herein by reference in its entirety.

### SUMMARY OF THE INVENTION

A method for fabricating a device having a barrier layer is provided. The method comprises depositing a barrier layer over a substrate. Depositing the barrier layer comprises depositing, via chemical vapor deposition, a first sublayer of the barrier layer using a first set of deposition parameters. The chemical vapor deposition uses a feed gas mixture comprising a non-deposition gas and a deposition gas. The first set of deposition parameters includes a power density, a deposition pressure, a non-deposition gas flow rate and a deposition gas flow rate. The flow ratio of non-deposition gas to deposition gas multiplied by the power density is greater than 13,000 mW/cm². The power density divided by deposition pressure is between 3.28 and 30 W/cm²/torr. The power density divided by the sum of the non-deposition gas flow rate and the deposition gas flow rate is between 0.5 and 18 mW/cm²/sccm. The power density divided by the precursor gas flow rate is between 20 and 200 mW/cm²/sccm. The material of the first barrier layer is selected to have a plasma etch rate less than 5 times the etch rate of thermally growth silicon oxide under the same etching conditions.

Preferably, during deposition of the first sublayer of the barrier layer, the growth rate of the first sublayer of the barrier layer is greater than 40 nm/min.

A preferred set of first deposition conditions includes: The flow ratio of non-deposition gas to deposition gas multiplied by the power density is greater than 32,000 mW/cm². The power density divided by deposition pressure is between 8 and 30 W/cm²/torr. The power density divided by the sum of the non-deposition gas flow rate and the deposition gas flow rate is between 2.4 and 18 mW/cm²/sccm. The power density divided by the precursor gas flow rate is between 100 and 200 mW/cm²/sccm. The material of the first barrier layer is selected to have a plasma etch rate less than 1.75 times the etch rate of thermally growth silicon oxide under the same etching conditions.

A preferred set of first deposition conditions includes: The power density divided by the sum of the non-deposition gas flow rate and the deposition gas flow rate is between 0.5 and 6.8 mW/cm²/sccm. The power density divided by the precursor gas flow rate is between 20 and 75 mW/cm²/sccm. The material of the first barrier layer is selected to have a plasma etch rate between 2.5 and 5 times the etch rate of thermally growth silicon oxide under the same etching conditions.

Preferably, during deposition of the first sublayer of the barrier layer, the growth rate of the first barrier layer is greater than 70 nm/min. This condition is particularly preferred in conjunction with the preferred set of first deposition conditions described in the preceding paragraph.

Depositing the barrier layer may further comprise depositing, via chemical vapor deposition, a second sublayer of the barrier layer using a second set of deposition parameters different from the first set of deposition parameters.

Preferably, the materials of the first and second sublayers of the barrier layer are selected such that the barrier layer has an average plasma etch rate less than 5 times the etch rate of thermally growth silicon oxide under the same etching conditions.

Preferably, and particularly when there is more than one sublayer in the barrier layer, wherein the average growth rate of the barrier layer is greater than 60 nm/min.

In one embodiment, the barrier layer is deposited over the device. Prior to depositing the barrier layer: A first electrode is deposited over a substrate. At least one device layer is deposited over the first electrode. A second electrode is deposited over the at least one device layer. Then, the barrier layer is deposited over the second electrode.

In one embodiment, the device is deposited over the barrier layer. After depositing the barrier layer on a substrate: A first electrode is deposited over the barrier layer. At least one device layer is deposited over the first electrode. A second electrode is deposited over the at least one device layer.

Any suitable substrate may be used. Examples include substrates made from materials such as glass, plastic, and metal foil. The substrate may or may not be planarized prior to depositing the barrier layer.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows a device having a barrier layer.

FIG. 4 shows photographs of the luminescent areas of BOLED test pixels coated with barrier film, taken at the start and after periods of accelerated storage at (a) 85° C. and 85% RH and (b) 65° C. and 85% RH conditions. All the devices have same barrier film. These tests illustrate relative rate of degradation at these two conditions.

FIG. 5 shows plots of normalized active pixel area vs storage time for BOLED test pixels coated with same barrier film stored at 85° C. and 85% RH and 65° C. and 85% RH conditions.

FIG. 6 shows photographs of the luminescent areas of TOLED test pixels coated with barrier film, taken at the start and after periods of accelerated storage at (a) 85° C. and 85% RH and (b) 65° C. and 85% RH conditions. All the devices have same barrier film. These tests give us relative rate of degradation at these two conditions.

FIG. 7 shows plots of normalized active pixel area vs storage time for TOLED test pixels coated with same barrier film stored at 85° C. and 85% RH and 65° C. and 85% RH conditions.

FIG. 8 shows photographs of the luminescent areas of TOLED test pixels coated with barrier film, taken at the start and after periods of accelerated storage at (a) 65° C. and 85% RH and (b) 85° C. and 85% RH conditions. All the devices have same barrier film. These tests illustrate relative rate of degradation at these two conditions.

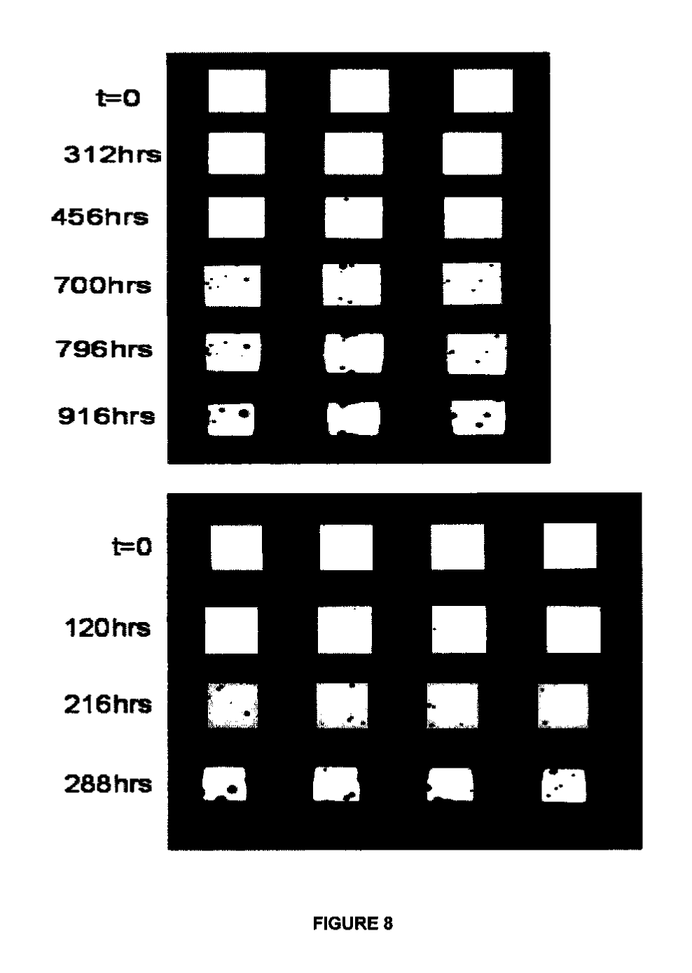

FIG. 9 shows plots of normalized active pixel area vs storage time for TOLED test pixels coated with same barrier film stored at 65° C. and 85% RH and 85° C. and 85% RH conditions.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

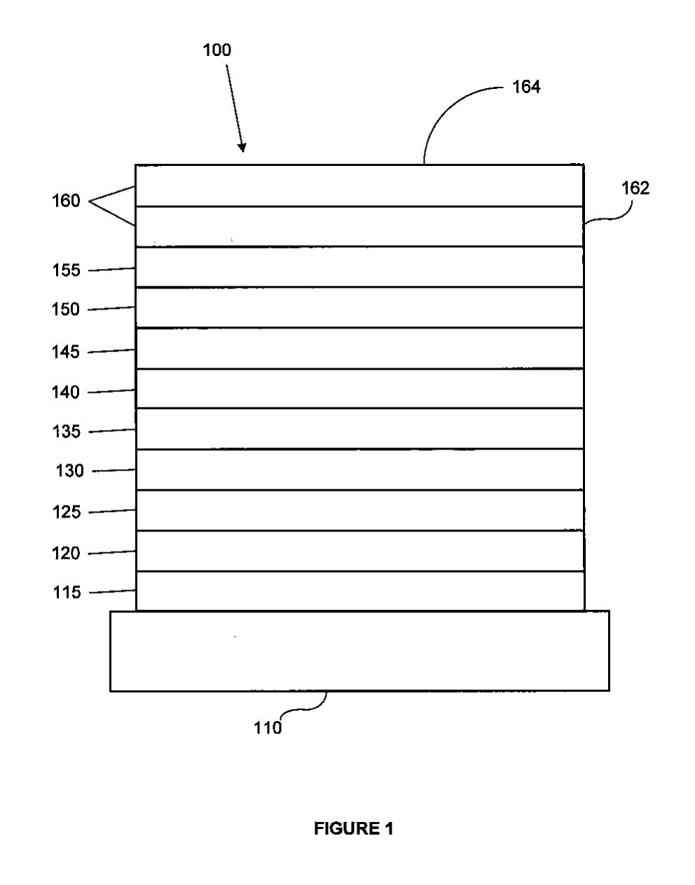

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F.sub.4-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

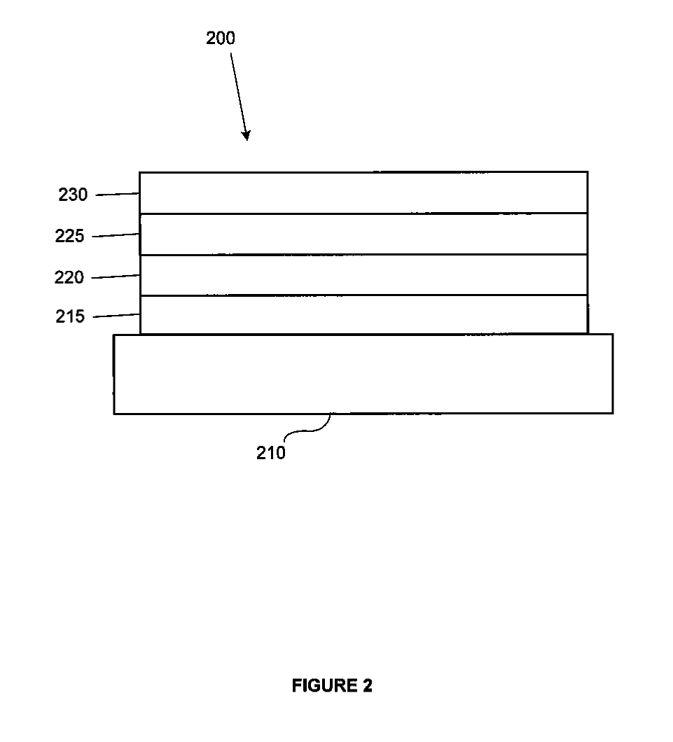

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processability than those having symmetric structures, because asymmetric materials may have a lower tendency to recrystallize. Dendrimer substituents may be used to enhance the ability of small molecules to undergo solution processing.

Devices fabricated in accordance with embodiments of the invention may be incorporated into a wide variety of consumer products, including flat panel displays, computer monitors, medical monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

The terms halo, halogen, alkyl, cycloalkyl, alkenyl, alkynyl, arylkyl, heterocyclic group, aryl, aromatic group, and heteroaryl are known to the art, and are defined in U.S. Pat. No. 7,279,704 at cols. 31-32, which are incorporated herein by reference.

A method for fabricating a device having a barrier layer is provided. The method comprises depositing a barrier layer over a substrate. Depositing the barrier layer comprises depositing, via chemical vapor deposition, a first sublayer of the barrier layer using a first set of deposition parameters. The chemical vapor deposition uses a feed gas mixture comprising a non-deposition gas and a deposition gas. The first set of deposition parameters includes a power density, a deposition pressure, a non-deposition gas flow rate and a deposition gas flow rate. The flow ratio of non-deposition gas to deposition gas multiplied by the power density is greater than 13,000 mW/cm². The power density divided by deposition pressure is between 3.28 and 30 W/cm²/torr. The power density divided by the sum of the non-deposition gas flow rate and the deposition gas flow rate is between 0.5 and 18 mW/cm²/sccm. The power density divided by the precursor gas flow rate is between 20 and 200 mW/cm²/sccm. Each of these parameters may be controlled in a relatively straightforward way by adjusting standard settings on a CVD apparatus. The material of the first barrier layer is selected to have a plasma etch rate less than 5 times the etch rate of thermally growth silicon oxide under the same etching conditions. Examples of precursors that lead to such a barrier layer are provided in the examples herein. In addition, plasma etch rate is an easily measured and often reported quantity.

Preferably, during deposition of the first sublayer of the barrier layer, the growth rate of the first sublayer of the barrier layer is greater than 40 nm/min. Growth rate may be readily adjusted in a reasonably predictable manner by adjusting parameters such as gas flow rate and power density.

A preferred set of first deposition conditions includes: The flow ratio of non-deposition gas to deposition gas multiplied by the power density is greater than 32,000 mW/cm². The power density divided by deposition pressure is between 8 and 30 W/cm²/torr. The power density divided by the sum of the non-deposition gas flow rate and the deposition gas flow rate is between 2.4 and 18 mW/cm²/sccm. The power density divided by the precursor gas flow rate is between 100 and 200 mW/cm²/sccm. The material of the first barrier layer is selected to have a plasma etch rate less than 1.75 times the etch rate of thermally growth silicon oxide under the same etching conditions.

A preferred set of first deposition conditions includes: The power density divided by the sum of the non-deposition gas flow rate and the deposition gas flow rate is between 0.5 and 6.8 mW/cm²/sccm. The power density divided by the precursor gas flow rate is between 20 and 75 mW/cm²/sccm. The material of the first barrier layer is selected to have a plasma etch rate between 2.5 and 5 times the etch rate of thermally growth silicon oxide under the same etching conditions.

Preferably, during deposition of the first sublayer of the barrier layer, the growth rate of the first barrier layer is greater than 70 nm/min. This condition is particularly preferred in conjunction with the preferred set of first deposition conditions described in the preceding paragraph.

Depositing the barrier layer may further comprise depositing, via chemical vapor deposition, a second sublayer of the barrier layer using a second set of deposition parameters different from the first set of deposition parameters.

Preferably, the materials of the first and second sublayers of the barrier layer are selected such that the barrier layer has an average plasma etch rate less than 5 times the etch rate of thermally growth silicon oxide under the same etching conditions.

Preferably, and particularly when there is more than one sublayer in the barrier layer, wherein the average growth rate of the barrier layer is greater than 60 nm/min.

In one embodiment, the barrier layer is deposited over the device. Prior to depositing the barrier layer: A first electrode is deposited over a substrate. At least one device layer is deposited over the first electrode. A second electrode is deposited over the at least one device layer. Then, the barrier layer is deposited over the second electrode.

In one embodiment, the device is deposited over the barrier layer. After depositing the barrier layer on a substrate: A first electrode is deposited over the barrier layer. At least one device layer is deposited over the first electrode. A second electrode is deposited over the at least one device layer.

Any suitable substrate may be used. Examples include substrates made from materials such as glass, plastic, and metal foil. The substrate may or may not be planarized prior to depositing the barrier layer.

Preferably, the first barrier consists of a stack of films differentiated from each other by their etch rates. The ratio of the average etch rate of the overall barrier film to that of thermally deposited silicon oxide under similar etching conditions is preferably less than 5 and the average growth rate of the film is preferably greater than 60 nm/min. The water vapor transmission rate and the lag time associated with the overall barrier film may be tuned solely by changing the proportions of the films with different etch rates.

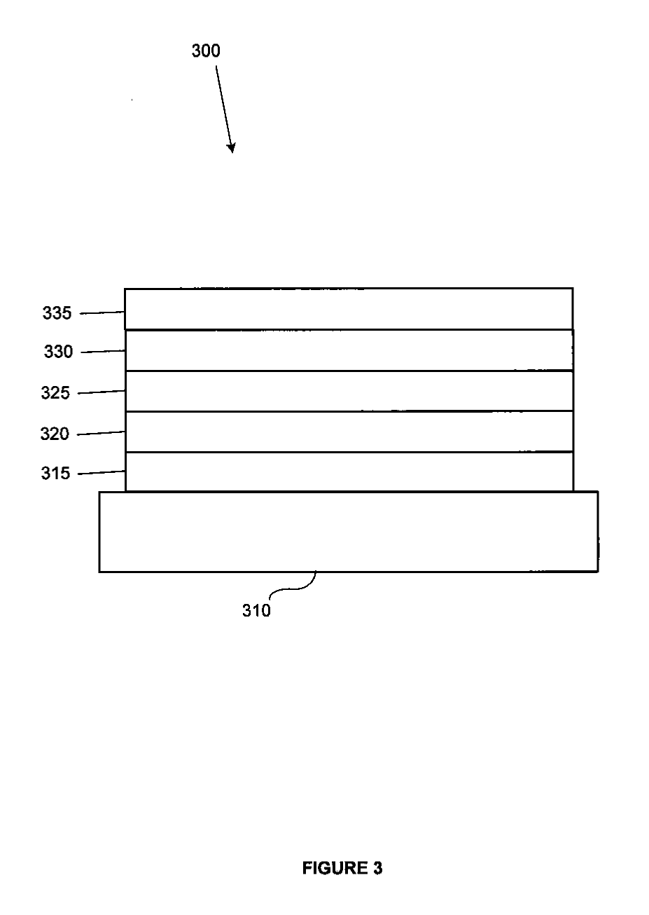

FIG. 3 shows an embodiment of the invention that includes two barrier layers. A device 300 with barrier layers is disposed over a substrate 310. The device includes a first barrier layer 315, a first electrode 320, a device layer 325, a second electrode 330, and a second barrier layer 335, disposed in that order over substrate 310. Preferably the device is an organic device. More preferably the device is an OLED. The use of the specific barrier layers described herein have been shown to be effective when used with organic devices such as OLEDs, but they may be used with other types of devices. Device layer 325 may represent a single layer, or may represent multiple layers disposed between electrodes as illustrated, for example, in FIGS. 1 and 2.

Embodiments of the invention may include barrier layers disposed both over (second barrier layer 335) and under (first barrier layer 315) the electrodes of a device as illustrated in FIG. 3. Or, only one of the barrier layers may be present. The use of only one barrier layer may be preferred when moisture penetration is only an issue from one direction. For example, where a substrate, or a subsequently deposited encapsulation layer, or an electrode, or some other structure or mechanism already provides adequate protection from moisture from one direction, it may be preferred to use a barrier layer only on the otherwise unprotected side of the device.

First and second barrier layers 315 and 335 may comprise multiple sublayers. In a preferred embodiment, there are multiple alternating layers, where every other sublayer has a similar composition, i.e., sublayers 1, 3, 5 and so on have similar composition and properties, and sublayers 2, 4, 6 and so on have similar composition and properties. It has been found that the inclusion of a sublayer of a barrier layer fabricated using specific parameters described herein has a strong effect on the effectiveness of the barrier layer, and many embodiments described herein focus on such a fabrication method, while leaving general whether there are additional sublayers and how any such additional sublayers are fabricated.

Embodiments of the invention describe a barrier film, and a method of making such a film, which may have its physical properties carefully tuned. Such tuning is useful in order to use the barrier film as a substrate barrier or device encapsulation. The diffusivity and solubility of water vapor when worked together with film thickness may give a wide range of lag times and WVTRs suitable for various applications.

OLEDs and other water sensitive devices degrade upon storage. There is a need to encapsulated such devices to prolong their shelf-life. Glass encapsulation is good for brittle devices made on glass but may be less useful for flexible or shatter-proof devices. Thin barrier films are preferred for such devices. Many new thin film encapsulation barriers have been reported over the past decade with water vapor transmission rates (WVTR) suitable for electronic devices such as OLEDs and solar cells. Two primary permeation parameters for a barrier film are the WVTR and the lag time. The WVTR (steady state permeation rate) is the most commonly used term. But lag time (time for the onset of degradation) is equally important. The WVTR as generally reported is not the only criteria to determine the quality of a thin film barrier. WVTR and lag time can be varied by varying the diffusion coefficient of water vapor and the solubility of water vapor in the barrier film, and the film thickness. The diffusion coefficient and the solubility can in turn be tuned by changing film density and composition. Film density and composition can be changed by changing film deposition conditions. A versatile barrier film should be tunable to achieve various levels of permeation properties, at the same time should have a sufficiently high deposition rate to fulfill industry standards. In this application, we describe a new barrier film, and a method for making such a barrier film, satisfying all the above criteria.

The most commonly researched barrier film currently, are the multilayer barrier films that consist of alternate layers of inorganic and organic films. The deposition time, edge ingress (permeation along the edge), cost effectiveness, and feasibility of such barrier films is still not clear. The barrier film we describe is not a multilayer barrier in the conventional sense as it is not a stack of inorganic and polymer films. It is preferably deposited in a single chamber CVD system. It preferably utilizes same precursor, such as hexamethlydisiloxane, throughout the film deposition. This barrier has a hybrid nature. It is partly oxide-like and partly polymer-like. Both the phases are intimately mixed at molecular level and thus making it a true hybrid instead of a multilayer film. The original version of the barrier film was first described in U.S. Ser. No. 11/783,361. Other preferred precursors can be utilized also such as tetraethoxysilane (TEOS), dimethyl siloxane (DMSO), octamethylcyclotetrasiloxane, hexamethyldisilazane, and mixtures thereof. More generally, preferred precursors include organosilanes, organosiloxanes, organosilazanes, and mixtures thereof.

The quality of a thin barrier film (TBF) is often measured in terms of its bulk permeation, which is expressed most commonly as water vapor transmission rate (WVTR). The most commonly quoted WVTR requirement for OLEDs is 10⁻⁶ g/m²/day. This value of WVTR was initially calculated from the amount of moisture required to consume commonly used cathode material (such as Mg or Ca). The WVTR is not an exclusive condition that should be met by the TBF. Below are the definitions of two significant permeation properties.

WVTR:

WVTR of a film is the steady state of flux of moisture across the film. It is directly proportional to the permeability of the film and the concentration gradient of moisture across the film thickness. It is given by

$$WVTR = {F}_{ss} = \frac{P Δ p}{l} \qquad ( 1 )$$

where Fₛₛ is the steady state flux of moisture across a film of thickness l, P is the moisture permeability of the film, and Δp is the difference in the partial pressure of moisture across the film thickness. In steady state, in accordance with Fick's diffusion model, the degradation of cathode from the water vapor traveling through the bulk of the TBF should be linear. Permeability itself is the product of water vapor diffusion coefficient, D and its solubility, S. That is, P=D×S.

Lag Time:

Detailed description of lag time can be found in G. L. Graff, R. E. Williford, and P. E. Burrows, J. Appl. Phys., 96 (4), pp. 1840-1849 (2004). Lag time is the delay in moisture arrival at the cathode of the device which is the result of barrier to moisture diffusion in the barrier film. Lag time is related to diffusion coefficient of water vapor, D and the thickness of the barrier film, l. Lag time may be defined as:

$${t}_{l} = \frac{{l}^{2}}{6 D} \qquad ( 2 )$$

### Relationship of Permeation Properties, Film Density, and Deposition Conditions:

Permeation properties such as WVTR, lag time, diffusion coefficient, solubility, etc. are related to film density and process conditions. The measurement of permeation properties generally involves a long experimentation time but film density to which permeation properties are directly related can be measured indirectly by using simple and fast experiments. Below using some examples we understand how all these parameters are interrelated and what part they play in determining the shelf-life of the encapsulated devices.

### Example 1

### Calculation of Permeation Properties by Environmental Testing:

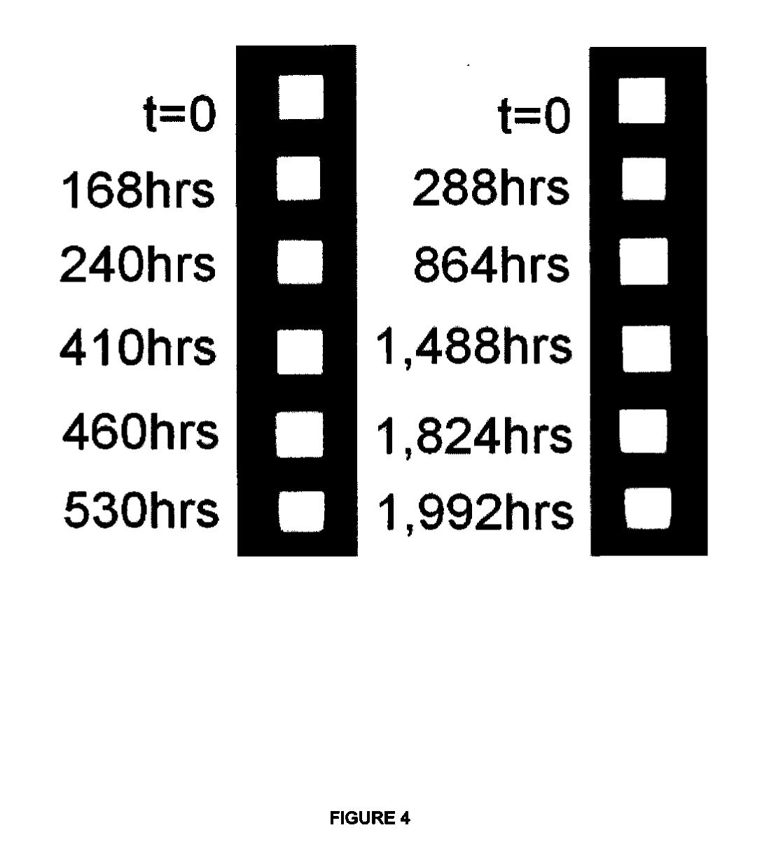

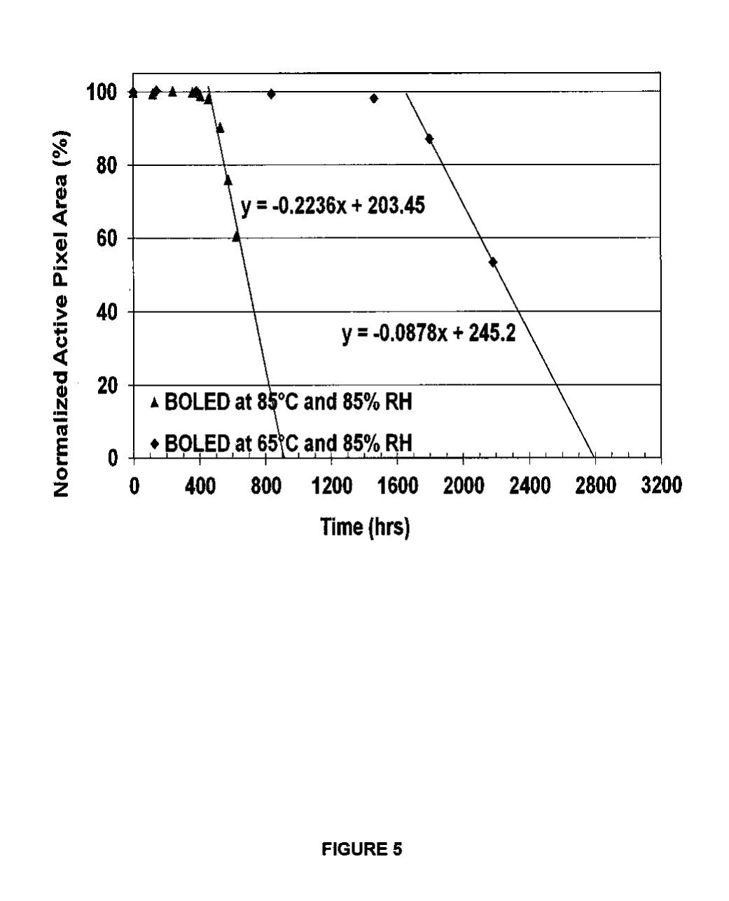

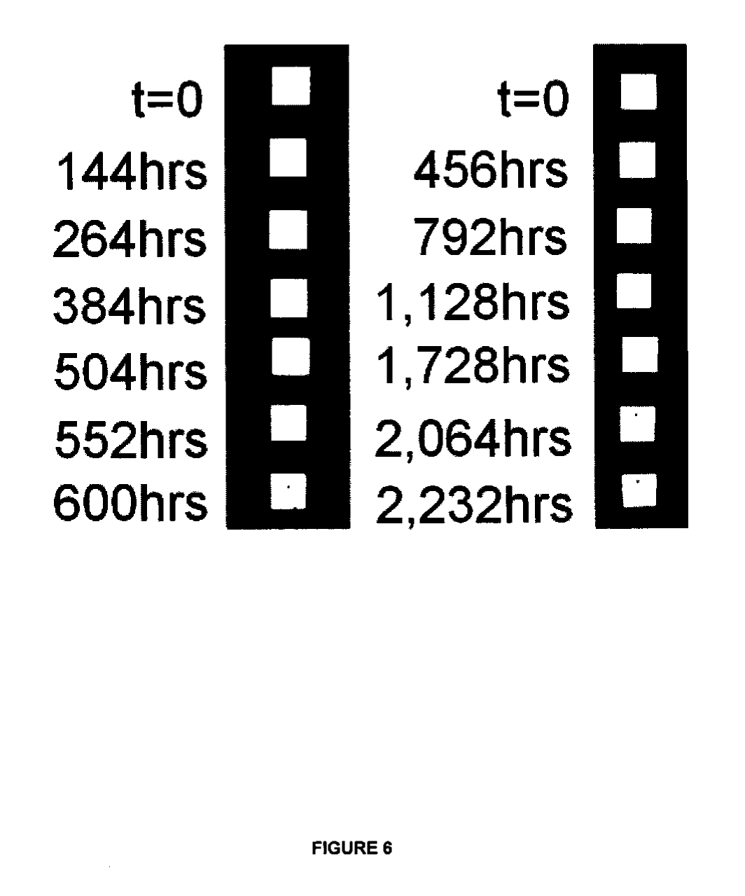

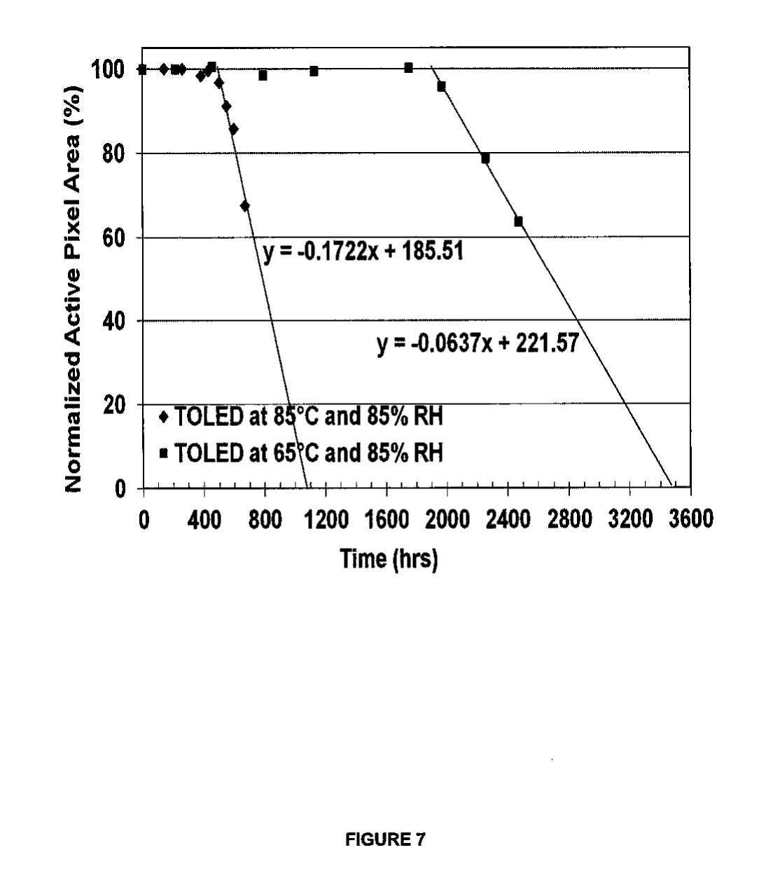

U.S. patent application Ser. No. 12/886,994 describes a barrier film grown by plasma deposition of HMDSO and oxygen. The process conditions described in example 1 are similar to those used in U.S. patent application Ser. No. 12/886,994. The barrier film was deposited on OLEDs and then tested at accelerated environmental conditions. This film had a WVTR of about 4.4×10⁻⁴ g/m²/day and a lag time more than 1,500 hrs at 65° C. and 85% RH using a 9 μm thick barrier film. How it was calculated is described later. The activation energy of diffusion of water vapor in the barrier film was ˜65.8 kJ/mole. This film was tested by encapsulating 2 mm² bottom emitting OLED (BOLED) and transparent OLED (TOLED) devices with the film, and storing them under different environmental testing conditions. The conditions used were the commonly used 65° C. and 85% RH and 85° C. and 85% RH. Depending on the test condition, the devices would degrade faster or slower during the tests. FIG. 4 shows the photographs of BOLED devices during the accelerated environmental tests. FIG. 5 shows the plot of the active device area of encapsulated BOLEDs measured along the duration of the accelerated environmental tests for both testing conditions. FIG. 6 shows the photographs of TOLED devices during the accelerated environmental tests. FIG. 7 shows the plot of the active device area of encapsulated TOLEDs measured along the duration of the accelerated environmental tests for both testing conditions.

From FIG. 5 for BOLEDs, we observe that lag time or the time to onset of device degradation is about 463 hrs for devices stored at 85° C. and 85% RH, whereas it is about 1,654 hrs for the devices stored at 65° C. and 85% RH. From FIG. 7 for TOLEDs, we observe that lag time or the time to onset of device degradation is about 497 hrs for devices stored at 85° C. and 85% RH, whereas it is about 1,909 hrs for the devices stored at 65° C. and 85% RH. The BOLED device had 200 nm thick A1 cathode whereas the TOLED device had 12 nm Mg—Ag (10% Ag) cathode. The performance of the barrier film on TOLEDs was better than on BOLEDs. To understand the reason we need to look at the mechanism of OLED degradation by moisture. The degradation, which is visible in form of dark spots, is caused by cathode consumption as well as cathode delamination. Thicker cathode does not necessary mean the entire thickness of cathode will react with moisture. Even if the interface of the cathode reacts with moisture and forms an insulating layer, it will appear as a dark spot in the device. We believe the thinner cathode in the TOLED devices is almost completely consumed by moisture, whereas the thicker cathode is not. In case of thicker cathode on the interface region close to organic layer reacts with moisture forming an insulating layer. This explains why the OLEDs with thinner cathode have longer shelf lifetime. Similar to the lag time, the steady state degradation rate, which is equivalent to WVTR also varies from one test condition to other. It can be calculated from the slope of the steady state degradation curve of the OLEDs as seen in FIGS. 5 and 7.

The ratio of lag times and steady state degradation rates at the two storage conditions are shown in Table 1. Comparing the data at 85° C. and 85% RH and 65° C. and 85% RH it is possible to calculate activation energies for diffusion and permeation. Using the activation energies, lag times and WVTRs at different storage conditions can be calculated.

TABLE 1
The ratios of lag times (tₗ) and WVTRs for different test conditions.

| | Ratio of tₗ (65° C./ | |
|---|---|---|
| | 85% RH/85° C./85% | Ratio of WVTR |
| Sample | RH) | (85° C./85% RH/65° C./85% RH) |
| BOLED | 3.6 | 2.6 |
| TOLED | 3.8 | 2.7 |

### Activation Energy for Diffusion:

Temperature dependence of diffusivity follows an Arrhenius relationship. It can be expressed as:

$$D = {D}_{0} exp ( \frac{- {E}_{D}}{RT} ) \qquad ( 3 )$$

where D₀ is maximum diffusivity and E_{D} is the activation energy for diffusion.

Using eq (2) and (3) we can express ratio of lag times at different temperatures as

$$\frac{{t}_{l} ( {T}_{2} )}{{t}_{l} ( {T}_{1} )} = exp ( \frac{{E}_{D}}{R} ( \frac{1}{{T}_{2}} - \frac{1}{{T}_{1}} ) ) \qquad ( 4 )$$

The ratio of lag times at 65° C. and 85% RH and 85° C. and 85% RH comes is ˜3.7 from table 1. This implies the activation energy of diffusion of moisture in the barrier film is ˜65.8 kJ/mole. Using the activation energy the ratio of lag times at 25° C. and 85% RH and 85° C. and 85% RH comes out to be ˜86. This implies a lag time of about 500 hrs at 85° C. and 85% RH is equivalent to a lag time of ˜5 years at 25° C. and 85% RH for an OLED with similar cathode. This is true for a barrier whose activation energy for moisture diffusion is ˜65.8 kJ/mole.

### Activation Energy for WVTR and Permeability:

From table 1 the average value of ratio of WVTRs at 85° C. and 85% RH and 65° C. and 85% RH comes out to be 2.65. As explained in G. L. Graff, R. E. Williford, and P. E. Burrows, J. Appl. Phys., 96 (4), pp. 1840-1849 (2004), WVTR is the steady state flux of moisture across the barrier film. It is related to moisture permeability and the concentration gradient of moisture across the barrier film thickness as described in eq. (1). Permeability is the product of diffusivity (D) and solubility (S) and follows Arrhenius temperature relationship. See, Sorption Behavior of an Aliphatic Series of Aldehydes in the Presence of Poly(ethylene terephthalate) Blends Containing Aldehyde Scavenging Agents, Eric Charles Suloff, Phd Thesis, Virginia Polytechnic Institute and State University (Suloff PhD thesis). The diffusivity describes the kinetics of molecular transport whereas the solubility describes the thermodynamic interaction between the permeant and the barrier film. See, Suloff PhD thesis. Like diffusivity solubility also follows Arrhenius temperature relationship. It can be expressed as:

$$S = {S}_{0 } exp ( \frac{- Δ {H}_{s}}{RT} ) \qquad ( 5 )$$

where S₀ is a constant and ΔH_{S} is molar enthalpy of sorption. Solubility for condensable permeants like water reduces with increasing temperature. See, Gas separation using polymer membranes: An overview, K. Ghosal, B. D. Freeman, Polym. Adv. Technol., 5, 673-697 (1994). The activation energy for permeation is the sum of activation energy for diffusion and enthalpy of sorption. Diffusion coefficient and solubility are independent of moisture concentration at low temperatures and so is solubility. See, Hajimu Wakabayashi and Minoru Tomozawa, J. Am. Cerum. Soc., 72 [lo] 1850-55 (1989) (Wakabayashi et al.). In case of polymer films, the thermodynamic process involving solubility is a two-step process. The process consists of the condensation of the permeant molecule, followed by creation of molecular scale gap to accommodate the molecule. Low molecular weight, low condensability gases, the second step of the process that is molecular mixing is more dominant. The enthalpy of mixing of permeant gases having weak interactions with polymer is positive making the solubility of such gases increase with temperature. For condensable gases and vapors, the process of condensation is dominant and has negative enthalpy making the solubility for such gases decrease with temperature. See, Wakabayashi et al.; Transport properties and their correlation with the morphology of thermally conditioned polypropylene, W. R. Vieth, W. F. Wuerth, J. Appl. Polym. Sci., 13, 685-712 (1969). As a function of temperature, Permeability can be expressed as:

$${P}_{0} exp ( \frac{- {E}_{p}}{RT} ) \qquad ( 6 )$$

where P₀ is the maximum permeability and E_{P} is the activation energy for permeation which is the sum of activation energy of diffusion, E_{D} and enthalpy of sorption, ΔH_{S}. The steady state flux of moisture across the barrier film or water vapor transmission rate is described in eq (1).

Combining eq (1) and (6) we get:

$${F}_{ss} = \frac{{P}_{0} exp ( \frac{- {E}_{p}}{RT} ) Δ p}{l} \qquad ( 7 )$$

where Δp is the difference in the partial pressure of water vapor outside (p) and that at the barrier film-cathode interface (0). The vapor pressure of water vapor at the cathode is assumed to be zero as it gets consumed. The ratio of WVTRs at different temperatures and relative humidity can be expressed as:

$$\frac{{F}_{ss} ( {T}_{2} , {p}_{2} ( {T}_{2} , {RH}_{2} ) )}{{F}_{ss} ( {T}_{1} , {p}_{1} ( {T}_{1} , {RH}_{1} ) )} = exp ( \frac{- {E}_{p}}{R} ( \frac{1}{{T}_{2}} - \frac{1}{{T}_{1}} ) ) ( \frac{{p}_{2}}{{p}_{1}} ) \qquad ( 8 )$$

The partial pressure of water vapor, p is related to temperature and relative humidity. It is related to maximum partial pressure of water vapor (saturation pressure), pₘₐₓ as:

$$p = {p}_{max} ( \frac{RH}{100} ) \qquad ( 9 )$$

Maximum partial pressure of water vapor in air is related to temperature. Various empirical relationships have been given to describe the variation of saturation water vapor pressure as a function of temperature such as Groff-Gratch equation. See Goff, J. A., and S. Gratch (1946) Low-pressure properties of water from −160 to 212° F., in Transactions of the American Society of Heating and Ventilating Engineers, pp 95-122, presented at the 52nd annual meeting of the American Society of Heating and Ventilating Engineers, New York, 1946; Arden-Buck equation [Buck, A. L. (1981), “New equations for computing vapor pressure and enhancement factor”, J. Appl. Meteorol. 20: 1527-1532. Table 2 shows saturated water vapor pressure at different temperatures.

TABLE 2
Saturated water vapor pressure at different temperatures.

| Temperature (° C.) | Saturated water vapor pressure, pₘₐₓ (atm) |
|---|---|
| 25 | 0.03 |
| 65 | 0.2467 |
| 85 | 0.57 |

From table 1, the average ratio of WVTRs at 85° C. and 85% RH and 65° C. and 85% RH is ˜2.65. Using eq. (8), the activation energy for permeation comes out to be ˜6.9 kJ/mole. This implies the enthalpy of sorption of water vapor in the barrier film is ˜−58.9 kJ/mole. Using the value of activation energy for permeation in eq. (8), the ratio of WVTRs at 85° C. and 85% RH and 25° C. and 40% RH comes out to be ˜64.

### Calculation of WVTR for the Barrier Film:

The shelflife performances of BOLEDs (FIG. 2) and TOLEDs (FIG. 4) coated with similar barrier film was comparable despite the difference in the cathode thicknesses. As mentioned before, we believe the reason to be incomplete consumption of the thicker cathode in the BOLEDs by water vapor. For this reason we use only the TOLED data for WVTR calculation of our barrier film.

We used 12 nm MgAg (10% Ag doped) as the cathode that is ˜11 nm thick Mg available for consumption. From FIG. 4, 100% MgAg gets consumed in about 1,500 hrs of storage at 65° C. and 85% RH. Density of MgAg is ˜1.7 g/cc. Molar mass of Mg is 24 g/mole and that of water is 18 g/mole. Each Mg atom reacts with 2 water molecules. From the rate of consumption of Mg, we get the WVTR ˜4.48×10⁻⁴ g/m²/day at 65° C. and 85% RH. This is equivalent to ˜1.18×10⁻³ g/m²/day at 85° C. and 85% RH and ˜1.85×10⁻⁵ g/m²/day at 25° C. and 40% RH. This WVTR may be affected by particulate assisted permeation and may be an underestimation of the actual value. We would call it as the upper limit of the WVTR of the barrier film. The WVTR can be varied by changing film thickness and composition. Increasing thickness would linearly decrease the WVTR. By changing film composition we can change the diffusivity and solubility of the film. The effect of changing diffusivity will reflect directly on lag time. Changing solubility will affect the WVTR in conjunction with diffusivity.

### Film Deposition Conditions and Film Density:

Using tables 3, 4 and 5, we describe how the film growth conditions affect film density. Tables 3 and 4 describe the plasma deposition conditions used to grow barrier film described in example 1. Table 5 describe the relative etch rate of the film when compared to thermal oxide and film growth rate. The etch rate of the barrier film is a measure of film density for these films. Thermally grown silicon oxide is grown at very high temperature and has minimal defects, and hence has a low etch rate. CVD films have more defects and are more porous so have a higher etch rate under similar etching conditions. Thus, comparing the etch rate of the film with that of thermal oxide tells us about the film density. Using example 1 and example 2, we will demonstrate that etch rate is related to permeation properties. It is shown that a film with higher density (or lower etch rate) performs better in environmental testing than a film with lower density (or lower etch rate).

TABLE 3
Process conditions for barrier film in example-1.

| | | | | | [Power | [Power | [Power | [Power |
|---|---|---|---|---|---|---|---|---|
| | | | | | density × | density/ | density/ | density/ |
| | | | Power | | O₂/HMDSO | Pressure] | HMDSO | total |
| Barrier | Oxygen | HMDSO | density | Pressure | flow rates] | (W/cm²/ | flow rate] | flow rate] |
| film | (sccm) | (sccm) | (mW/cm²) | (mTorr) | (mW/cm²) | torr) | (mW/sccm/cm²) | (mW/sccm/cm²) |
| Film-a | 158 | 5 | 1,000 | 122 | 31,600 | 8.2 | 200 | 6.13 |
| Film-b | 290 | 9 | 410 | 122 | 13,211 | 3.36 | 45.5 | 1.37 |

TABLE 4
Overall film composition for barrier film in example-1.

| | | | | | Total |
|---|---|---|---|---|---|
| | | | | | barrier |
| | | | | | film |
| | | Film-a | Film-b | Thickness | thickness |
| Substrate | | (nm) | (nm) | (nm) | (nm) |
| BOLEDs | First two | 400 | 550 | x 1 = 950 | = 8950 |
| and | layers | | | | |
| TOLEDs | Subsequent | 240 | 560 | x 10 = 8000 | |
| | layers | | | | |

TABLE 5
Etch rate ratio and growth rate of films used in example-1.

| | [Plasma etch rate | |
|---|---|---|
| | of film/plasma | |
| | etch rate of | Growth rate |
| Barrier film | thermal oxide] | (nm/min) |
| Film-a | 1.17 | 40 |
| Film-b | 2.93 | 68 |

The barrier film described above consists of two layers both deposited in the same reactor chamber. Film-a, which was deposited at high (power density/HMDSO flow rate), whereas film-b was deposited with lower similar parameter. Controlling the ratio of the two films in the overall barrier film helped us tune the permeation characteristics of the entire stack. Film-a had high density so its etch rate was similar to that of thermal oxide, second layer was of lower density and its etch rate was higher than that of thermal oxide as can be seen in table 5. The closer the etch rate of the barrier film is to the thermal oxide, the denser the film is.

Example-2 will clarify the roll of film density in defining the permeation characteristics of that barrier film.

### Example 2

### Calculation of Permeation Properties by Environmental Testing:

Another example using the process similar to that described in U.S. patent application Ser. No. 12/886,994 is described below. The barrier film described in this examples had a WVTR of about 1.58×10⁻³ g/m²/day and a lag time of about 764 hrs at 65° C. and 85% RH with 9 μm thick barrier film. 2 mm² TOLED devices, were encapsulated with this film, and stored under different environmental testing conditions. The conditions that used were the commonly used 65° C. and 85% RH and 85° C. and 85% RH. FIG. 5 shows the photographs of TOLED devices during the accelerated environmental tests. FIG. 6 shows the plot of the active device area of encapsulated TOLEDs measured along the duration of the accelerated environmental tests for both testing conditions.

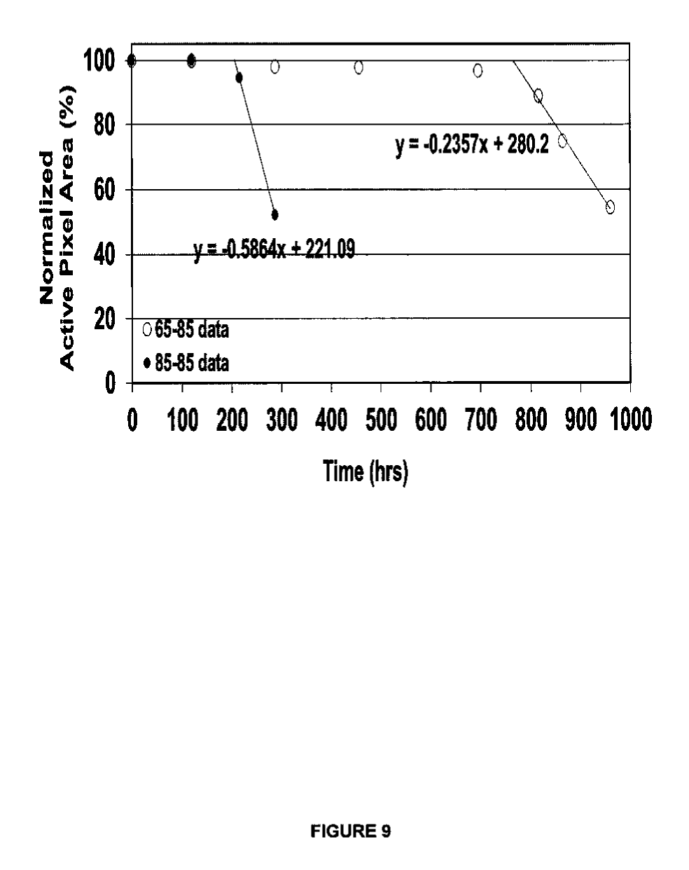

From FIG. 9 for TOLEDs, we observe that lag time or the time to onset of device degradation is about 206 hrs for devices stored at 85° C. and 85% RH, whereas it is about 764 hrs for the devices stored at 65° C. and 85% RH. The ratio of lag times and steady state degradation rates at the two storage conditions are shown in Table 6. Comparing the data at 85° C. and 85% RH and 65° C. and 85% RH it is possible to calculate activation energies for diffusion and permeation. Using the activation energies lag times and WVTRs at different storage conditions can be calculated.

TABLE 6
The ratios of lag times and WVTRs for barrier film in example-2

| | Ratio of tₗ (65° C./85% | Ratio of WVTR (85° C./85% |
|---|---|---|
| | RH/85° C./85% | RH/65° C./85% |
| Sample | RH) | RH) |
| TOLED | 3.7 | 2.5 |

Using the calculations from the example 1 above, we can calculate the activation energies and actual WVTR for this film. The activation energy for diffusion of water vapor in this barrier is similar to that of the film in example 1 (ratio of lag times under different conditions is same) which is ˜65.8 kJ/mole. From table 6, the average ratio of WVTRs at 85° C. and 85% RH and 65° C. and 85% RH is ˜2.5, which is within the measurement error range. From FIG. 9, 100% MgAg gets consumed in about 425 hrs of storage at 65° C. and 85% RH. Density of MgAg is ˜1.7 g/cc. Molar mass of Mg is 24 g/mole and that of water is 18 g/mole. Each Mg atom reacts with 2 water molecules. From the rate of consumption of Mg, we get the WVTR ˜1.58×10⁻³ g/m²/day at 65° C. and 85% RH.

### Film Deposition Conditions and Film Density:

Using tables 7, 8 and 9, we describe how the film growth conditions affect film density. Tables 7 and 8 describe the plasma deposition conditions used to grow barrier film described in example 2. Table 9 describe the relative etch rate of the film when compared to thermal oxide and film growth rate.

TABLE 7
Process conditions for barrier film in example-2.

| | | | | | [Power | [Power | [Power | [Power |
|---|---|---|---|---|---|---|---|---|
| | | | | | density × | density/ | density/ | density/ |
| | | | Power | | O₂/HMDSO | Pressure] | HMDSO | total |
| Barrier | Oxygen | HMDSO | density | Pressure | flow rates] | (W/cm²/ | flow rate] | flow rate] |
| film | (sccm) | (sccm) | (mW/cm²) | (mTorr) | (mW/cm²) | torr) | (mW/sccm/cm²) | (mW/sccm/cm²) |
| Film-a | 160 | 5 | 1,110 | 126 | 35,520 | 8.81 | 222 | 6.73 |
| Film-b | 320 | 10 | 493 | 106 | 15,776 | 4.65 | 49.3 | 1.49 |
| Film-c | 290 | 9 | 493 | 106 | 15,300 | 4.65 | 54.8 | 1.64 |

TABLE 8
Overall film composition for barrier film in example-2.

| | | | | | Total |
|---|---|---|---|---|---|
| | | | | | barrier |
| | | | | | film |
| | | Film-a | Film-c | Thickness | thickness |
| Substrate | | (nm) | (nm) | (nm) | (nm) |
| BOLEDs | First two | 260 | 350 | x 1 = 950 | = 9,450 |
| and | layers | | | | |
| TOLEDs | | | | | |
| | Subsequent | Film-a | Film-b | | |
| | layers | (nm) | (nm) | | |
| | | 35 | 390 | x 20 = 8,500 | |

TABLE 9
Etch rate ratio and growth rate of films used in example-2.

| | [Plasma etch rate | |
|---|---|---|
| | of film/plasma | |
| | etch rate of | Growth rate |
| Barrier film | thermal oxide] | (nm/min) |
| Film-a | 1.17 | 40 |
| Film-c | 2.4 | 70 |
| Film-b | 2.93 | 68 |

The barrier film used in this example had comparatively worse permeation properties when compared to the film described in example 1. This film had higher content of low density (high etch rate film), which accounts for its higher overall WVTR and diffusion coefficient of water vapor.

From the examples above we learn that the easily measurable intrinsic film properties such as film density are related to other physical properties such as WVTR and permeation rate etc. We can utilize film density as a reliable tool to estimate the permeation properties of the barrier film. In the two examples by controlling the etch rate (and hence film density) and the ratio of high and low density films in the overall barrier, the lag time and the WVTR of the overall barrier film was controlled. For the film described in example-1 in which the proportion of the high density film was higher, the WVTR was about 4.4×10⁻⁴ g/m²/day and a lag time was >1,500 hrs at 65° C. and 85% RH for a 9 μm thick barrier film. Whereas, for the film in example-2, in which the proportion of high density film was lower, the WVTR was about 1.58×10⁻³ g/m²/day and a lag time was about 764 hrs at 65° C. and 85% RH for 9 μm thick barrier film. More than an order of magnitude reduction in the WVTR and about a 100% increase in the lag time was obtained just by increasing the high density film portion in the overall barrier film. Even greater effect on the WVTR and the lag time can be achieved by changing the relative ratios of the high and the low density films in the overall barrier film. Thickness can be another variable for tuning the WVTR and the lag time for the barrier film. But thickness of the overall barrier film can be restricted by the particulate size in the system. Particulates must be encapsulated to get the required benefit out of the barrier film. Unencapsulated or partially encapsulated particulates leak and increase the average permeation through the barrier film causing dark spots to form in the encapsulated device.

The films described in examples 1 and 2 were not viable to grow commercial barrier films because of the overall slow film growth rates. The growth rate of the film-a used in example-1 was about 40 nm/min and that of film-b was about 68 nm/min. The average growth rate of the entire barrier film was about 60 nm/min.

### New Barrier Film and Process:

A barrier film which can be deposited at a faster growth rate still maintaining the barrier performance would be ideal. The general accepted trend for sputtered or plasma deposited film is higher the growth rate, lower the film density. See, U.S. patent application Ser. No. 12/886,994. Higher growth rate allows less time for atomic rearrangement which would lead higher density. The goal was to grow barrier films with densities and hence permeation properties similar to those shown in example 1 but enhance the growth rate. We proceeded to increase the deposition rate of both the high density and low density films without changing their respective densities so that the overall barrier film grown using these two films can be made commercially viable.

We chose a few process parameters to work with. These process parameters were gas flow ratio, area power density, area power density/deposition pressure, area power density/HMDSO flow rate, and area power density/total flow rate.

### High Density Films:

We define high density films as the films whose etch rate is no more than 1.75 times that of thermally grown silicon oxide under similar etching conditions. For our tests we utilized CF₄/O₂ plasma for etching the films.

Tables 10 and 11 show different processes to deposit high density films at growth rates higher than film-a (of example-1), which is described in row 1 in the table. The first parameter that was changed to increase the deposition rate was HMDSO gas flow rate. Increasing the flow rate of the deposition gas would increase the deposition rate. But that alone is not enough. More HMDSO in the system means more energy required to break the HMDSO molecules, otherwise most of the added HMDSO molecules would remain unreacted and go unutilized. Also without this extra energy there is chance of gas phase reaction between the additionally available HMDSO molecules. This extra energy is provided by increasing the area power density. So the next factor we modified was area power density/HMDSO gas flow rate. For high density films it remained above 100 mW/sccm/cm². The next factor was gas flow ratio. As the deposition rate was increased the gas flow ratio was reduced somewhat but still kept close to the original gas flow rate ratio, which was 32. The gas flow rate ratio was reduced somewhat with increasing area power density to prevent the non-deposition species from overpowering the deposition species. As the power density is increased there is a chance that the non-deposition species in the plasma might make the plasma less of a growth plasma and more of an etching plasma. Also increasing the HMDSO slightly helped us keep the film density more or less constant. In other words, increasing area power density should be coupled with a slight reduction in the oxygen/HMDSO gas flow ratio to maintain film density and keep the film from becoming brittle due to excess oxygen. But the increase in area power density was generally kept more than the reduction in the oxygen/HMDSO flow ratio such that the parameter area power density×oxygen/HMDSO flow rate increased as we went higher and higher in deposition rates for the high density films. This was preferred both for increased growth rate and maintaining the film density.

One other factor is the volume power density. The distance between the parallel plate capacitors that was utilized for our experiments was kept more or less constant for both the high density and the low density films, so the volume and area power densities for both type of films scaled similarly. But the volume power density of the high density films was higher than that of the low density films along with higher area power density, which is evident in the higher deposition rate for the high density film for similar HMDSO flow rate. High volume power density is important for obtaining high deposition rates. The reason why we didn't go for high volume power densities for the low density films was to prevent them from becoming highly compressively stressed. The high density films had higher compressive stress than the low density films. For this reason both high and low density films were important to obtain a good overall barrier film. The high density film would provide the primary barrier property whereas the low density film would bring the total stress down and keep the overall barrier mechanically intact.

The work described here was performed with a parallel plate capacitor PECVD system coupled with a ˜27 MHz RF power supply. But the plasma can be an inductively couple plasma created away from the substrate coupled with higher or lower frequency power supply. It is believed that power density, gas flow rates and pressure criteria described herein would also apply on other CVD systems. Increasing frequency causes more efficient fragmentation of gas molecules. So higher frequency than what we used may require lower power density than what we used in our system to achieve similar quality films.

TABLE 10
Various barrier films and processes conditions to grow them.

| | | | | | | [Area power | [Power | [Area power | [Area power |
|---|---|---|---|---|---|---|---|---|---|
| | | | Area | Volume | | density × | density/ | density/ | density/ |
| | | Oxygen/ | power | power | | O₂/HMDSO | Pressure] | HMDSO | total |
| Barrier | HMDSO | HMDSO | density | density | Pressure | flow rates] | (W/cm²/ | flow rate] | flow rate] |
| film | (sccm) | flow rate | (mW/cm²) | (mW/cm³) | (mTorr) | (mW/cm²) | torr) | (mW/sccm/cm²) | (mW/sccm/cm²) |
| Film-a | 5 | 32 | 1,000 | 645 | 125 | 32,000 | 8 | 200 | 6.06 |
| Film-1 | 9 | 31.11 | 1,110 | 716 | 125 | 34,532 | 8.88 | 123.3 | 3.84 |
| Film-2 | 9 | 32.22 | 1,066 | 687 | 125 | 34,347 | 8.52 | 118.4 | 3.57 |
| Film-3 | 12 | 30.6 | 1,480 | 955 | 125 | 45,263 | 11.84 | 123.3 | 3.9 |
| Film-4 | 12.5 | 29.36 | 1,539 | 993 | 125 | 45,185 | 12.31 | 123.1 | 4.05 |
| Film-5 | 13.2 | 30.3 | 1,628 | 1,050 | 125 | 49,328 | 13 | 123.3 | 3.94 |

TABLE 11
Normalized etch rates and growth rates of barrier films from table 10.

| | [Plasma etch rate of | |
|---|---|---|
| | film/plasma etch | |
| | rate of thermal | Growth rate |
| Barrier film | oxide] | (nm/min) |
| Film-a | 1.17 | 40 |
| Film-1 | 1.18 | 125 |
| Film-2 | 1.37 | 129 |
| Film-3 | 1.29 | 170 |
| Film-4 | 1.26 | 168 |
| Film-5 | 1.25 | 176 |

Ranges of Parameters for High Density Film and their Enablement:

The area power density that was utilized for the high density film in example-1 was about 1,000 mW/cm². We took it all the way up to 1,628 mW/cm² for the highest growth rate high density film. It can be taken further up with a larger system with high gas flow rate capability and bigger pumps to maintain pressure. Area power density up to 10,000 mW/cm² seem reasonable for a large system to grow the high density films at very high growth rates. Power density/HMDSO flow rate should be at least 100 mW/sccm/cm² to get reasonably dense high density film, which means the HMDSO flow rate cannot be more than 100 sccm. The highest power density/HMDSO flow rate that we believe can be used without the films becoming too stressed or the etching portion of plasma becoming dominant is about 200 mW/sccm/cm². The flow ratio of oxygen to HMDSO should be kept below 40 for such high power densities to prevent plasma from becoming etching dominant and films from becoming brittle but no less than 10 to prevent the films from becoming polymer-like and low density. Therefore, for the highest preferred HMDSO flow rate for the high density film (100 sccm for a system with 10,000 mW/cm² power density) the flow rate of oxygen should be no more than 4,000 sccm to prevent the plasma from becoming oxygen species rich and causing the formation of brittle or etching dominant. Correspondingly, the power density/total gas flow rate ratio would lie between 2.4 and 18 mW/sccm/cm². The pressure could also be increased for very high gas flow rates but should be kept below 500 mtorr so as to avoid running in to gas phase nucleation.

### Low Density Films:

We define low density films as the films whose etch rate is no less than 2.5 times but also not more than 5 times that of thermally grown silicon oxide under similar etching conditions. For our tests we utilized CF4/O2 plasma for etching the films.

Tables 12 and 13 show the progress of the low density film to higher growth rate. For increasing the growth rate of low density film, without making them porous, more or less similar approach was used as for the high density film. The difference between the high and the low density films was in their area and volume power densities, area power density/HMDSO flow rate, area power density/total gas flow rate, and to some extent deposition pressure. All the values for the low density films were lower than the high density films with similar deposition rates. The deposition pressure was increased in case of low density films as the deposition rate went up primarily to prevent the deposited films from becoming too compressively stressed. Very high area power density at low deposition pressure would make the films become highly compressively stressed.

TABLE 12
Various barrier films and processes conditions to grow them.

| | | | | | | [Power | [Power | [Power | [Power |
|---|---|---|---|---|---|---|---|---|---|
| | | | | Volume | | density × | density/ | density/ | density/ |
| | | Oxygen/ | Power | power | | O₂/HMDSO | Pressure] | HMDSO | total |
| Barrier | HMDSO | HMDSO | density | density | Pressure | flow rates] | (W/cm²/ | flow rate] | flow rate] |
| film | (sccm) | flow rate | (mW/cm²) | (mW/cm³) | (mTorr) | (mW/cm²) | torr) | (mW/sccm/cm²) | (mW/sccm/cm²) |
| Film-b | 9 | 32.22 | 410 | 210 | 125 | 13,210 | 3.28 | 45.6 | 1.37 |
| Film-1 | 18 | 27 | 513 | 257 | 137 | 13,851 | 3.75 | 28.5 | 1.02 |
| Film-2 | 18 | 26.39 | 615 | 308 | 137 | 16,230 | 4.49 | 34.2 | 1.25 |
| Film-3 | 27 | 31.48 | 923 | 462 | 200 | 29,056 | 4.62 | 34.2 | 1.05 |
| Film-4 | 32 | 31.25 | 1,093 | 547 | 222 | 34,156 | 4.92 | 34.2 | 1.06 |
| Film-5 | 32 | 31.25 | 1,230 | 615 | 222 | 38,438 | 5.54 | 38.4 | 1.19 |
| Film-6 | 36 | 27.8 | 1,517 | 759 | 227 | 42,173 | 6.68 | 42.1 | 1.46 |

Power density was increased along with total gas flow rate (to maintain film density), but the ratio of flow rates of non-deposition gas to deposition gas was reduced slightly (to prevent the non-deposition plasma species to become dominant and reduce the growth rate). The pressure was increased to prevent too sharp a reduction in the residence time of gases in the reaction chamber and also to prevent internal stress from becoming very high. But power density/pressure was increased to impart sufficient energy in to the deposition species and prevent powder formation because of too much gas phase reaction. Power density/HMDSO flow rate was kept lower that the film-b from example 1 (that is the flow rate of HMDSO was increased along with power density). Power density/total gas flow rate was also kept lower than that of film-b from example 1.

TABLE 13
Normalized etch rates and growth rates of barrier films from table 10.

| | [Plasma etch rate of | |
|---|---|---|
| | film/plasma etch | |
| | rate of thermal | Growth rate |
| Barrier film | oxide] | (nm/min) |
| Film-b | 2.93 | 68 |
| Film-1 | 3.36 | 107 |
| Film-2 | 3.06 | 117 |
| Film-3 | 3.04 | 155 |
| Film-4 | 3.17 | 162 |
| Film-5 | 3.16 | 172 |
| Film-6 | 3.45 | 231 |

Ranges of Parameters for Low Density Films and their Enablement:

The area power density that was utilized for the low density film in example-1 was about 410 mW/cm2. We took it all the way up to 1,517 mW/cm2 for the highest growth rate low density film. It can be taken further up with a larger system with high gas flow rate capability and bigger pumps to maintain pressure. Area power density up to 10,000 mW/cm2 seem reasonable to grow the low density films at high growth rates. Power density/HMDSO flow rate should be below 75 mW/sccm/cm2 to prevent films from getting too highly stressed but above 20 mW/sccm·cm2 to prevent films from becoming very low density and polymer-like, which means the HMDSO flow rate cannot be less than 133 sccm and no more than 500 sccm for a system with area power density of 10,000 mW/cm2. Oxygen to HMDSO flow rate ratio for these low density films again should be kept between (10) and 40 for the same reasons as mentioned for the high density films. So for a system with a very high power density capability of 10,000 mW/cm2, the power density/total gas flow rate should be between 0.5 and 6.84 mW/sccm/cm2 in order to obtain barrier films whose etch rate is no less than 2.5 times thermal oxide but no more than 5 times also. The pressure could also be increased for very high gas flow rates but should be kept below 500 mtorr so as to avoid running in to gas phase nucleation.

### Plasma Etching Process Utilized for Obtaining the Etch Rates:

All the films were deposited on Si wafers and were subjected to CF₄/O₂ plasma in the same PECVD reactor to obtain the plasma etch rates. Thermally grown SiO₂ films, which are readily available in the market, were loaded along with the barrier film deposited Si wafers to obtain the relative etch rates. High density films tend to have lower etch rates so the etch rates can be used to indirectly infer film densities. The process utilized for plasma etching is shown in table 14. Film thicknesses were measured before and after the etching process using an ellipsometer to calculate the etch rates. Thermal silicon oxide is used as the benchmark because of its ready availability and more or less similar quality from substrate to substrate, which is because it is grown at very high temperature, very slowly so as to have a low defect count and a uniform microstructure. It can be used to evaluate relative densities of many CVD grown thin film silicon containing compounds such as silicon oxide, oxynitride, oxycarbide, nitride, carboxynitride, hydroxycarbide etc. The etching mechanism is fluorine species reacting with the silicon in the thin film and forming a volatile compound. The remaining constituents such as carbon, hydrogen, carbon or nitrogen for gaseous species also and escape the reactor. Only type of films whose etch rates can be misleading can be highly polymerized films with high amount of carbon and low amount of silicon. For such films low etch rates can be seen even at low film densities. But in such cases other parameters such as refractive index, contact angle of deionized water droplet on surface of the film, indentation hardness, Young's modulus can be used to identify the polymerized film, which by itself will act as a poor permeation barrier. A useful permeation barrier will have aforementioned properties similar to that of thermal silicon oxide, whereas a polymerized film will not. Another test that can be used to test such films is permeability test itself, though it takes longer duration than previously mentioned tests.

TABLE 14
Plasma etching recipe for barrier films and thermally grown SiO₂ film.

| | Oxygen | | Power density | Pressure | Time |
|---|---|---|---|---|---|
| Film | (sccm) | CF₄ (sccm) | (mW/cm²) | (mTorr) | (min) |
| Barrier films | 40 | 200 | 550 | 300 | 0.5-1* |
| and thermal | | | | | |
| silicon oxide | | | | | |

*Time can depend on film thickness. Longer for thicker films and shorter for thinner.

Combination with Other Materials

The materials described herein as useful for a particular layer in an organic light emitting device may be used in combination with a wide variety of other materials present in the device. For example, emissive dopants disclosed herein may be used in conjunction with a wide variety of hosts, transport layers, blocking layers, injection layers, electrodes and other layers that may be present. The materials described or referred to below are non-limiting examples of materials that may be useful in combination with the compounds disclosed herein, and one of skill in the art can readily consult the literature to identify other materials that may be useful in combination.

### HIL/HTL:

A hole injecting/transporting material to be used in the present invention is not particularly limited, and any compound may be used as long as the compound is typically used as a hole injecting/transporting material. Examples of the material include, but not limit to: a phthalocyanine or porphryin derivative; an aromatic amine derivative; an indolocarbazole derivative; a polymer containing fluorohydrocarbon; a polymer with conductivity dopants; a conducting polymer, such as PEDOT/PSS; a self-assembly monomer derived from compounds such as phosphonic acid and sliane derivatives; a metal oxide derivative, such as MoOₓ; a p-type semiconducting organic compound, such as 1,4,5,8,9,12-Hexaazatriphenylenehexacarbonitrile; a metal complex, and a cross-linkable compounds.

Examples of aromatic amine derivatives used in HIL or HTL include, but not limit to the following general structures:

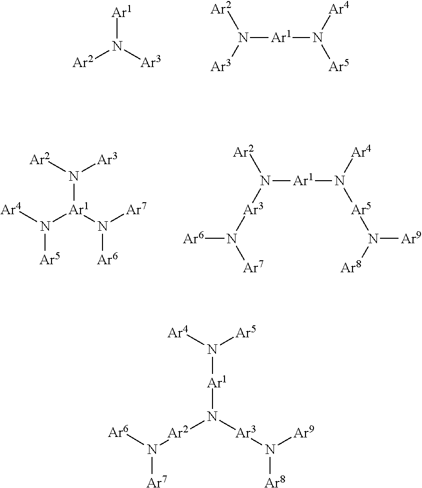

Each of Ar¹ to Ar⁹ is selected from the group consisting aromatic hydrocarbon cyclic compounds such as benzene, biphenyl, triphenyl, triphenylene, naphthalene, anthracene, phenalene, phenanthrene, fluorene, pyrene, chrysene, perylene, azulene; group consisting aromatic heterocyclic compounds such as dibenzothiophene, dibenzofuran, dibenzoselenophene, furan, thiophene, benzofuran, benzothiophene, benzoselenophene, carbazole, indolocarbazole, pyridylindole, pyrrolodipyridine, pyrazole, imidazole, triazole, oxazole, thiazole, oxadiazole, oxatriazole, dioxazole, thiadiazole, pyridine, pyridazine, pyrimidine, pyrazine, triazine, oxazine, oxathiazine, oxadiazine, indole, benzimidazole, indazole, indoxazine, benzoxazole, benzisoxazole, benzothiazole, quinoline, isoquinoline, cinnoline, quinazoline, quinoxaline, naphthyridine, phthalazine, pteridine, xanthene, acridine, phenazine, phenothiazine, phenoxazine, benzofuropyridine, furodipyridine, benzothienopyridine, thienodipyridine, benzoselenophenopyridine, and selenophenodipyridine; and group consisting 2 to 10 cyclic structural units which are groups of the same type or different types selected from the aromatic hydrocarbon cyclic group and the aromatic heterocyclic group and are bonded to each other directly or via at least one of oxygen atom, nitrogen atom, sulfur atom, silicon atom, phosphorus atom, boron atom, chain structural unit and the aliphatic cyclic group. Wherein each Ar is further substituted by a substituent selected from the group consisting of hydrogen, deuterium, halide, alkyl, cycloalkyl, heteroalkyl, arylalkyl, alkoxy, aryloxy, amino, silyl, alkenyl, cycloalkenyl, heteroalkenyl, alkynyl, aryl, heteroaryl, acyl, carbonyl, carboxylic acids, ester, nitrile, isonitrile, sulfanyl, sulfinyl, sulfonyl, phosphino, and combinations thereof.

In one aspect, Ar¹ to Ar⁹ is independently selected from the group consisting of:

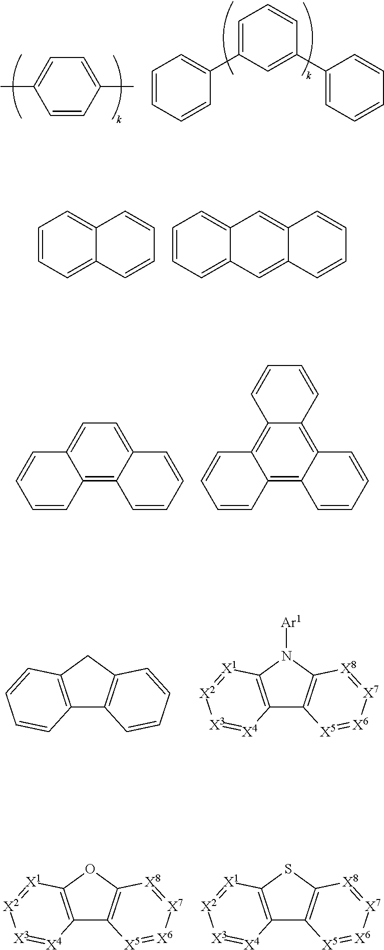

k is an integer from 1 to 20; X¹ to X⁸ is C (including CH) or N; Ar¹ has the same group defined above.

Examples of metal complexes used in HIL or HTL include, but not limit to the following general formula:

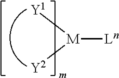

M is a metal, having an atomic weight greater than 40; (Y¹-Y²) is a bidentate ligand, Y¹ and Y² are independently selected from C, N, O, P, and S; L is an ancillary ligand; m is an integer value from 1 to the maximum number of ligands that may be attached to the metal; and m+n is the maximum number of ligands that may be attached to the metal.

In one aspect, (Y¹-Y²) is a 2-phenylpyridine derivative.

In another aspect, (Y¹-Y²) is a carbene ligand.

In another aspect, M is selected from Ir, Pt, Os, and Zn.

In a further aspect, the metal complex has a smallest oxidation potential in solution vs. Fc⁺/Fc couple less than about 0.6 V.

### Host:

The light emitting layer of the organic EL device of the present invention preferably contains at least a metal complex as light emitting material, and may contain a host material using the metal complex as a dopant material. Examples of the host material are not particularly limited, and any metal complexes or organic compounds may be used as long as the triplet energy of the host is larger than that of the dopant. While the Table below categorizes host materials as preferred for devices that emit various colors, any host material may be used with any dopant so long as the triplet criteria is satisfied.

Examples of metal complexes used as host are preferred to have the following general formula:

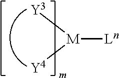

M is a metal; (Y³-Y⁴) is a bidentate ligand, Y³ and Y⁴ are independently selected from C, N, O, P, and S; L is an ancillary ligand; m is an integer value from 1 to the maximum number of ligands that may be attached to the metal; and m+n is the maximum number of ligands that may be attached to the metal.

In one aspect, the metal complexes are:

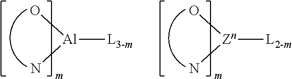

(O—N) is a bidentate ligand, having metal coordinated to atoms O and N.

In another aspect, M is selected from Ir and Pt.

In a further aspect, (Y³-Y⁴) is a carbene ligand.

Examples of organic compounds used as host are selected from the group consisting aromatic hydrocarbon cyclic compounds such as benzene, biphenyl, triphenyl, triphenylene, naphthalene, anthracene, phenalene, phenanthrene, fluorene, pyrene, chrysene, perylene, azulene; group consisting aromatic heterocyclic compounds such as dibenzothiophene, dibenzofuran, dibenzoselenophene, furan, thiophene, benzofuran, benzothiophene, benzoselenophene, carbazole, indolocarbazole, pyridylindole, pyrrolodipyridine, pyrazole, imidazole, triazole, oxazole, thiazole, oxadiazole, oxatriazole, dioxazole, thiadiazole, pyridine, pyridazine, pyrimidine, pyrazine, triazine, oxazine, oxathiazine, oxadiazine, indole, benzimidazole, indazole, indoxazine, benzoxazole, benzisoxazole, benzothiazole, quinoline, isoquinoline, cinnoline, quinazoline, quinoxaline, naphthyridine, phthalazine, pteridine, xanthene, acridine, phenazine, phenothiazine, phenoxazine, benzofuropyridine, furodipyridine, benzothienopyridine, thienodipyridine, benzoselenophenopyridine, and selenophenodipyridine; and group consisting 2 to 10 cyclic structural units which are groups of the same type or different types selected from the aromatic hydrocarbon cyclic group and the aromatic heterocyclic group and are bonded to each other directly or via at least one of oxygen atom, nitrogen atome, sulfur atom, silicon atom, phosphorus atom, boron atom, chain structural unit and the aliphatic cyclic group. Wherein each group is further substituted by a substituent selected from the group consisting of hydrogen, deuterium, halide, alkyl, cycloalkyl, heteroalkyl, arylalkyl, alkoxy, aryloxy, amino, silyl, alkenyl, cycloalkenyl, heteroalkenyl, alkynyl, aryl, heteroaryl, acyl, carbonyl, carboxylic acids, ester, nitrile, isonitrile, sulfanyl, sulfinyl, sulfonyl, phosphino, and combinations thereof.

In one aspect, host compound contains at least one of the following groups in the molecule:

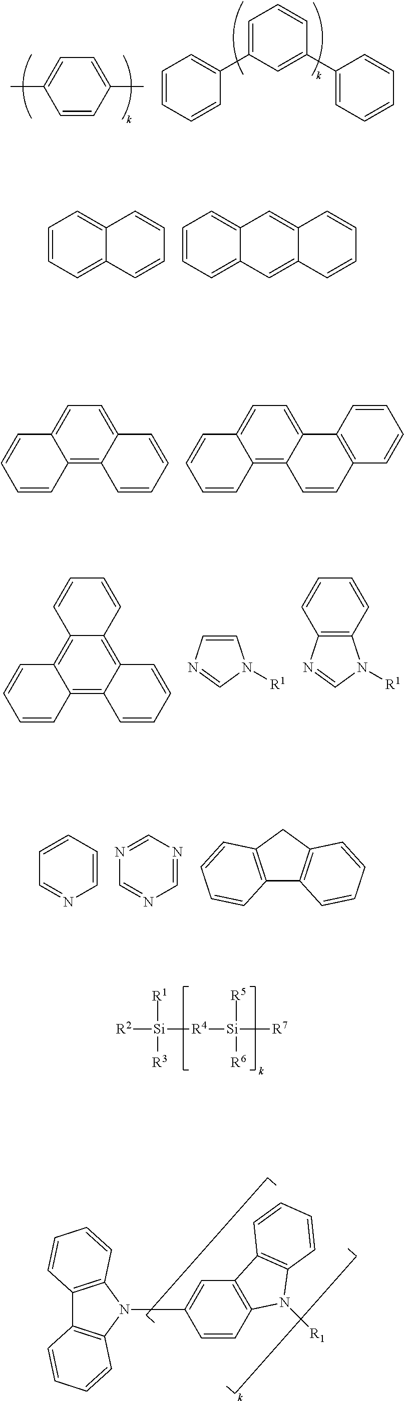

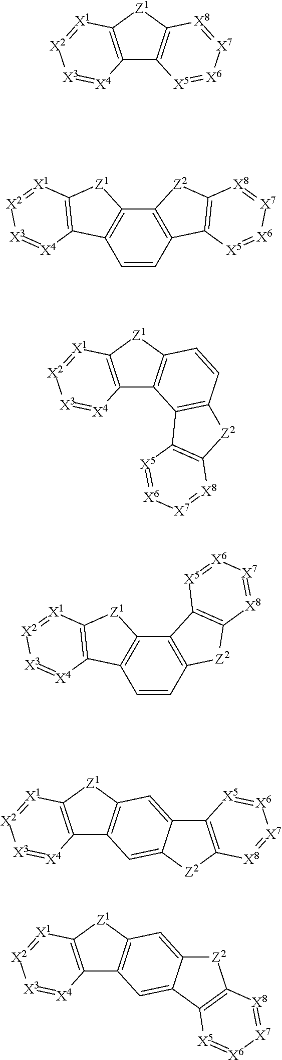

R¹ to R⁷ is independently selected from the group consisting of hydrogen, deuterium, halide, alkyl, cycloalkyl, heteroalkyl, arylalkyl, alkoxy, aryloxy, amino, silyl, alkenyl, cycloalkenyl, heteroalkenyl, alkynyl, aryl, heteroaryl, acyl, carbonyl, carboxylic acids, ester, nitrile, isonitrile, sulfanyl, sulfinyl, sulfonyl, phosphino, and combinations thereof, when it is aryl or heteroaryl, it has the similar definition as Ar's mentioned above.

k is an integer from 0 to 20.

X¹ to X⁸ is selected from C (including CH) or N.

Z¹ and Z² is selected from NR¹, O, or S.

### HBL:

A hole blocking layer (HBL) may be used to reduce the number of holes and/or excitons that leave the emissive layer. The presence of such a blocking layer in a device may result in substantially higher efficiencies as compared to a similar device lacking a blocking layer. Also, a blocking layer may be used to confine emission to a desired region of an OLED.

In one aspect, compound used in HBL contains the same molecule or the same functional groups used as host described above.

In another aspect, compound used in HBL contains at least one of the following groups in the molecule:

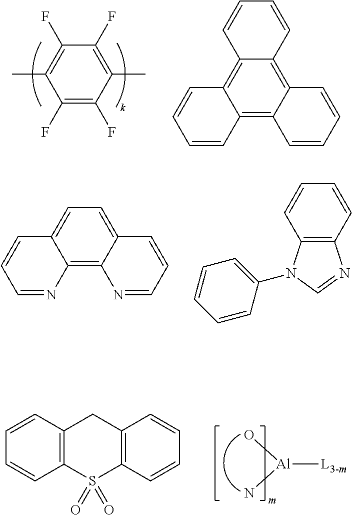

k is an integer from 0 to 20; L is an ancillary ligand, m is an integer from 1 to 3.

### ETL:

Electron transport layer (ETL) may include a material capable of transporting electrons. Electron transport layer may be intrinsic (undoped), or doped. Doping may be used to enhance conductivity. Examples of the ETL material are not particularly limited, and any metal complexes or organic compounds may be used as long as they are typically used to transport electrons.

In one aspect, compound used in ETL contains at least one of the following groups in the molecule:

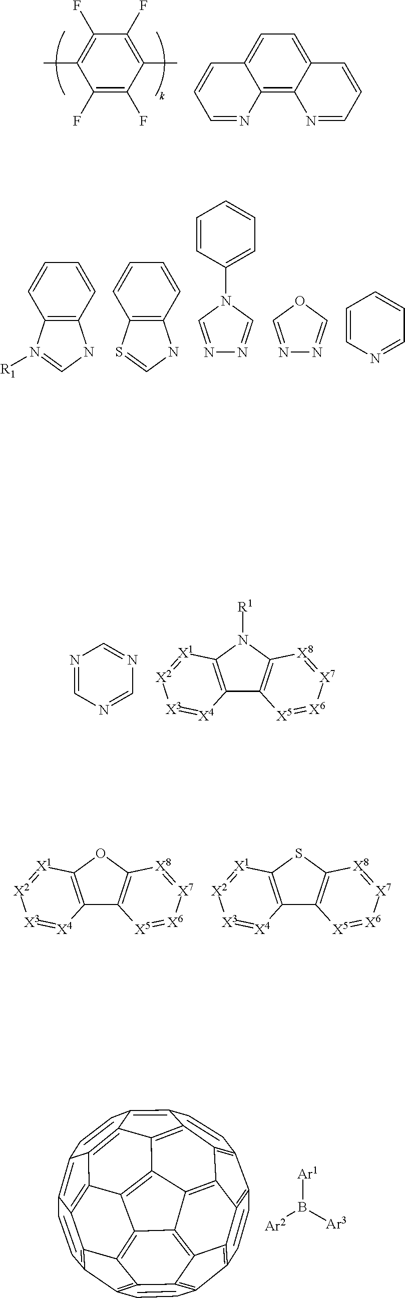

R¹ is selected from the group consisting of hydrogen, deuterium, halide, alkyl, cycloalkyl, heteroalkyl, arylalkyl, alkoxy, aryloxy, amino, silyl, alkenyl, cycloalkenyl, heteroalkenyl, alkynyl, aryl, heteroaryl, acyl, carbonyl, carboxylic acids, ester, nitrile, isonitrile, sulfanyl, sulfinyl, sulfonyl, phosphino, and combinations thereof, when it is aryl or heteroaryl, it has the similar definition as Ar's mentioned above.

Ar¹ to Ar³ has the similar definition as Ar's mentioned above.

k is an integer from 0 to 20.

X¹ to X⁸ is selected from C (including CH) or N.

In another aspect, the metal complexes used in ETL contains, but not limit to the following general formula:

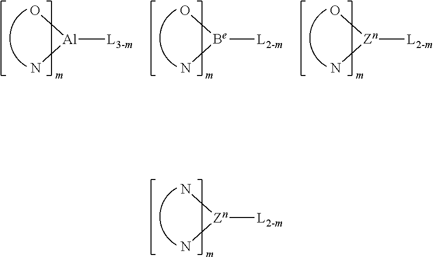

(O—N) or (N—N) is a bidentate ligand, having metal coordinated to atoms O, N or N, N; L is an ancillary ligand; m is an integer value from 1 to the maximum number of ligands that may be attached to the metal.

In any above-mentioned compounds used in each layer of the OLED device, the hydrogen atoms can be partially or fully deuterated.

In addition to and/or in combination with the materials disclosed herein, many other hole injection materials, hole transporting materials, host materials, dopant materials, exiton/hole blocking layer materials, electron transporting and electron injecting materials may be used in an OLED.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

1. A method for fabricating a device having a barrier layer, comprising:
depositing a barrier layer over a substrate;
wherein depositing the barrier layer comprises depositing, via chemical vapor deposition, a first sublayer of the barrier layer using a first set of deposition parameters;
wherein the chemical vapor deposition uses a feed gas mixture comprising a non-deposition gas and a deposition gas;
wherein the first set of deposition parameters includes a power density, a deposition pressure, a non-deposition gas flow rate and a deposition gas flow rate, and wherein:
the flow ratio of non-deposition gas to deposition gas multiplied by the power density is greater than 13,000 mW/cm²;
the power density divided by deposition pressure is between 3.28 and 30 W/cm²/torr;
the power density divided by the sum of the non-deposition gas flow rate and the deposition gas flow rate is between 0.5 and 18 mW/cm²/sccm and the power density divided by the precursor gas flow rate is between 20 and 200 mW/cm²/sccm;
and wherein the material of the first barrier layer is selected to have a plasma etch rate less than 5 times the etch rate of thermally growth silicon oxide under the same etching conditions.

2. The method of claim 1, wherein, during deposition of the first sublayer of the barrier layer, the growth rate of the first sublayer of the barrier layer is greater than 40 nm/min.

3. The method of claim 1, wherein during deposition of the first sublayer of the barrier layer:
the flow ratio of non-deposition gas to deposition gas multiplied by the power density is greater than 32,000 mW/cm²;
the power density divided by deposition pressure is between 8 and 30 W/cm²/torr;
the power density divided by the sum of the non-deposition gas flow rate and the deposition gas flow rate is between 2.4 and 18 mW/cm²/sccm and the power density divided by the precursor gas flow rate is between 100 and 200 mW/cm²/sccm;
and the material of the first barrier layer is selected to have a plasma etch rate less than 1.75 times the etch rate of thermally growth silicon oxide under the same etching conditions.

4. The method of claim 1, wherein during deposition of the first sublayer of the barrier layer:
the power density divided by the sum of the non-deposition gas flow rate and the deposition gas flow rate is between 0.5 and 6.8 mW/cm²/sccm and
the power density divided by the precursor gas flow rate is between 20 and 75 mW/cm²/sccm;
and the material of the first barrier layer is selected to have a plasma etch rate between 2.5 and 5 times the etch rate of thermally growth silicon oxide under the same etching conditions.

5. The method of claim 4, wherein, during deposition of the first sublayer of the barrier layer, the growth rate of the first sublayer of the barrier layer is greater than 70 nm/min.

6. The method of claim 1, wherein depositing the barrier layer further comprises depositing, via chemical vapor deposition, a second sublayer of the barrier layer using a second set of deposition parameters different from the first set of deposition parameters.

7. The method of claim 1, wherein the materials of the first and second sublayers of the barrier layer are selected such that the barrier layer has an average plasma etch rate less than 5 times the etch rate of thermally growth silicon oxide under the same etching conditions.

8. The method of claim 7, wherein the average growth rate of the barrier layer is greater than 60 nm/min.

9. The method of claim 1, further comprising, prior to depositing the barrier layer:
a) depositing a first electrode over a substrate;
b) depositing at least one device layer over the first electrode; and
c) depositing a second electrode over the at least one device layer.

10. The method of claim 1, further comprising, after depositing the barrier layer:
a) depositing a first electrode over the barrier layer;
b) depositing at least one device layer over the first electrode; and
c) depositing a second electrode over the at least one device layer.

11. The method of claim 10, wherein the substrate comprises a material selected from the group consisting of glass, plastic, and metal foil.

12. The method of claim 11 wherein the substrate is planarized prior to depositing the barrier layer.
